(19) United States
(12) Patent Application Publication
(10) Pub. No.: US 2022/0274498 A1
(43) Pub. Date: Sep. 1, 2022

(54) DISCHARGING VEHICLE AND VEHICLE CHARGING SYSTEM

(71) Applicant: BYD COMPANY LIMITED, Shenzhen, Guangdong (CN)

(72) Inventors: Bingjian HUANG, Shenzhen (CN); Hao LV, Shenzhen (CN); Axi QI, Shenzhen (CN); Zhifei YANG, Shenzhen (CN)

(21) Appl. No.: 17/630,816

(22) PCT Filed: Jul. 30, 2020
(86) PCT No.: PCT/CN2020/105882

§ 371 Date: Jan. 27, 2022

(30) Foreign Application Priority Data
Jul. 31, 2019 (CN) 201910703490.4

(51) Int. Cl. B60L 53/53; B60L 53/20; B60L 15/32; B60L 53/18; H02P 27/06; H02J 7/00; H02M 7/5387

(52) U.S. Cl. CPC B60L 53/53; B60L 53/20; B60L 15/32; B60L 53/18; H02P 27/06; H02J 7/007; H02M 7/5387; H02J 2207/20; H02P 2201/11

(57) ABSTRACT

The present disclosure relates to the technical field of vehicles, and provides a discharging vehicle and a vehicle charging system. The discharging vehicle includes a discharging control device, a first power battery, a motor, and a motor control circuit. A first electrode and a second electrode of the first power battery are respectively connected to a first input terminal and a second input terminal of the motor control circuit. The discharging control device realizes, by using the motor control circuit, DC step-down charging of the second power battery by the first power battery.

### CROSS-REFERENCE TO RELATED APPLICATIONS

The present disclosure claims priority of Chinese Patent Application No. 201910703490.4, filed on Jul. 31, 2019 and entitled “DISCHARGING VEHICLE AND VEHICLE CHARGING SYSTEM”. The entire content of the application is incorporated herein by reference.

### FIELD

The present disclosure relates to the field of charging technologies, and in particular, to a discharging vehicle and a vehicle charging system.

### BACKGROUND

With the development of the electric vehicle industry, a fast charging technology has become a key technology for electric vehicles. A dedicated DC charging station (charging cabinet) can achieve quick charging for batteries of the electric vehicles. However, such infrastructure is fixed and immovable, and therefore cannot satisfy all charging requirements of the electric vehicles.

### SUMMARY

The present disclosure is intended to resolve at least one of the technical problems in the related art to some extent.

To this end, the present disclosure is intended to provide a discharging vehicle, to achieve DC step-down charging of a low-voltage vehicle by a high-voltage vehicle by using a motor and a motor control circuit of the vehicle.

The present disclosure is further intended to provide a vehicle charging system.

In order to achieve the above purposes, an embodiment of a first aspect of the present disclosure proposes a discharging vehicle. The discharging vehicle includes a discharging control device, a first power battery, a motor, and a motor control circuit. The motor includes three-phase winding inductors and a neutral wire connected to the three-phase winding inductors. A first electrode of the first power battery is connected to a first input terminal of the motor control circuit. A second electrode of the first power battery is connected to a second input terminal of the motor control circuit. Three output terminals of the motor control circuit are respectively connected to the three-phase winding inductors. When the discharging vehicle establishes a charging connection to an external to-be-charged vehicle by using a charging connection device, the neutral wire is connected to a first electrode of a second power battery of the to-be-charged vehicle by the charging connection device, the second electrode of the first power battery is connected to a second electrode of the second power battery by the charging connection device, and the discharging control device is configured to control the motor control circuit, so as to realize DC step-down charging of the second power battery by the first power battery.

During establishment of the connection to the to-be-charged vehicle by using the external charging connection device to charge the to-be-charged vehicle, the discharging vehicle in this embodiment of the present disclosure can realize, by using the motor and the motor control circuit of the discharging vehicle, DC step-down charging of the to-be-charged vehicle by the discharging vehicle. The structure is simple and is easy to realize, and the cost is low.

In order to achieve the above purposes, an embodiment of a second aspect of the present disclosure provides a vehicle charging system. The vehicle charging system includes the discharging vehicle in the embodiment of the first aspect, a to-be-charged vehicle, and a charging connection device connected therebetween. The to-be-charged vehicle includes a charging control device and a second power battery. A first electrode of the second power battery is connected to the neutral wire by the charging connection device, and a second electrode of the second power battery is connected to the second electrode of the first power battery by the charging connection device.

The vehicle charging system in this embodiment of the present disclosure can realize, by using the motor control circuit and the motor windings of the discharging vehicle, DC step-down charging of the to-be-charged vehicle by the discharging vehicle. The structure is simple and is easy to realize, and the cost is low.

Part of additional aspects and advantages of the present disclosure is provided in the following description. The part will be apparent from the following description, or is learned by practice of the present disclosure.

### BRIEF DESCRIPTION OF THE DRAWINGS

FIG. 1 is a schematic structural diagram of a vehicle charging system according to a first embodiment of the present disclosure.

FIG. 2 is a schematic structural diagram of a vehicle charging system according to a second embodiment of the present disclosure.

FIG. 3 is a structural block diagram of a step-down circuit according to an embodiment of the present disclosure.

FIG. 4 is a schematic diagram of a working principle of the step-down circuit according to an embodiment of the present disclosure.

FIG. 5 is a schematic structural diagram of a vehicle charging system according to a fourth embodiment of the present disclosure.

FIG. 6 is a schematic structural diagram of a vehicle charging system according to a fifth embodiment of the present disclosure.

FIG. 7 is a schematic diagram of single-phase charging according to an example of the present disclosure.

FIG. 8 is a schematic diagram of two-phase charging according to an example of the present disclosure.

FIG. 9 is a schematic diagram of three-phase charging according to an example of the present disclosure.

### DETAILED DESCRIPTION

The following describes embodiments of the present disclosure in detail. Examples of the embodiments are shown in the accompanying drawings, and same or similar reference signs in all the accompanying drawings indicate same or similar components or components having same or similar functions. The embodiments described below with reference to the accompanying drawings are exemplary, and are intended to explain the present disclosure and cannot be construed as a limitation to the present disclosure.

A discharging vehicle and a vehicle charging system in the embodiments of the present disclosure are described below with reference to the drawings.

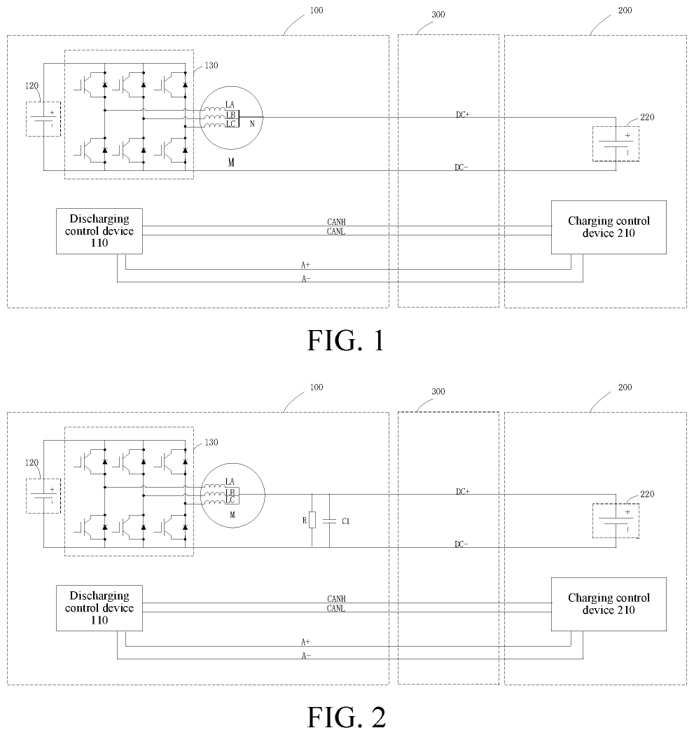

FIG. 1 is a schematic structural diagram of a discharging vehicle according to an embodiment of the present disclosure. As shown in FIG. 1, the discharging vehicle 100 includes a discharging control device 110, a first power battery 120, a motor control circuit 130, and a motor M. The motor M includes three-phase winding inductors LA, LB, LC and a neutral wire N. The neutral wire N is connected to one ends of the three-phase winding inductors LA, LB, and LC. A first electrode of the first power battery 120 is connected to a first input terminal of the motor control circuit 130. A second electrode of the first power battery 120 is connected to a second input terminal of the motor control circuit 130. Three output terminals of the motor control circuit 130 are respectively connected to the three-phase winding inductors LA, LB, and LC.

Referring to FIG. 1, when the discharging vehicle 100 establishes a charging connection to a to-be-charged vehicle 200 by using an external charging connection device 300, the neutral wire N is connected to a first electrode of a second power battery 220 of the to-be-charged vehicle 200 by the charging connection device 300, and the second electrode of the first power battery 120 is connected to a second electrode of the second power battery 220 by the charging connection device 300.

In this embodiment, the first electrode may be a positive electrode and the second electrode may be a negative electrode. The discharging control device 110 is configured to control the motor control circuit 130 to realize DC step-down charging of the second power battery 220 by the first power battery 120.

In particular, referring to FIG. 1, the motor control circuit 130 may be a three-phase bridge inverter circuit, which is composed of 6 switch tubes (such as an insulated gate bipolar transistor (IGBT) tube or a metal oxide semiconductor (MOS) tube). The motor control circuit 130 of the discharging vehicle 100 and the three-phase winding inductors LA, LB, and LC of the motor M are used, the neutral wire N is led out as a positive electrode, and the negative electrode of the first power battery 120 is used as a negative electrode, the positive terminal and the negative terminals are respectively connected to the positive electrode and the negative electrode of the second power battery 220 of the to-be-charged vehicle 200 by the charging connection device 300, and an upper-bridge switch tube is controlled to be turned on or off, thereby realizing high-power DC step-down charging. The discharging vehicle can realize, by using the motor control circuit and the motor windings, charging of a low-voltage electric vehicle by a high-voltage electric vehicle. The structure is simple and is easy to realize, and the cost is low.

In an embodiment of the present disclosure, as shown in FIG. 2, the discharging vehicle 100 further includes a bleeder resistor R and a first capacitor C1. One end of the bleeder resistor R is connected to the neutral wire N, and an other end of the bleeder resistor R is connected to the second electrode of the first power battery 120. The first capacitor C1 is connected in parallel to the bleeder resistor R. By adding the first capacitor and the bleeder resistor to the positive terminal and the negative terminal, stable high-power DC step-down can be realized, and ripple voltages and currents can be reduced. In addition, the first capacitor C1 further has a voltage division function, which reduces the adverse impact of the higher voltage of the discharging vehicle 100 on the lower voltage of the to-be-charged vehicle 200 and realizes voltage reduction.

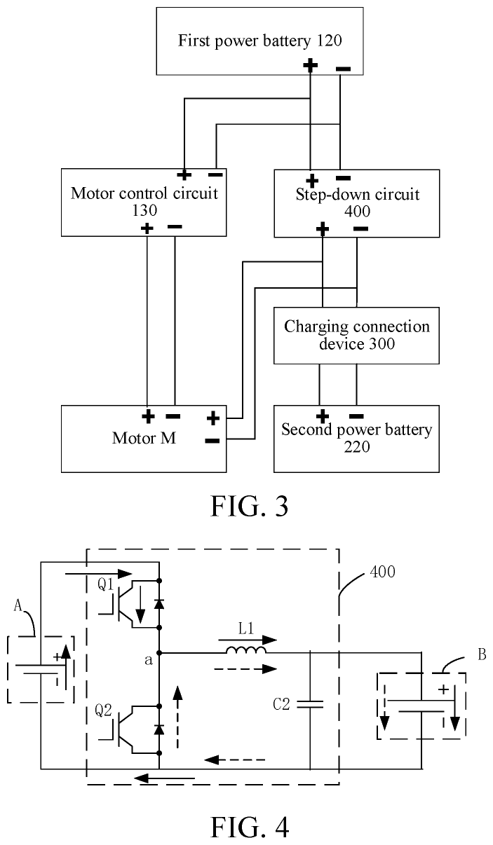

In an embodiment of the present disclosure, as shown in FIG. 3, the discharging vehicle 100 further includes a step-down circuit 400. A first input terminal of the step-down circuit 400 is connected to the first electrode of the first power battery 120. A second input terminal of the step-down circuit 400 is connected to the second electrode of the first power battery 120. A first output terminal of the step-down circuit 400 is connected to the first electrode of the second power battery 220 by the charging connection device 300. A second output terminal of the step-down circuit 400 is connected to the second electrode of the second power battery 220 by the charging connection device 300. The step-down circuit 400 is configured to realize DC step-down charging of the second power battery 220 by the first power battery 120.

Specifically, as shown in FIG. 4, the step-down circuit 400 includes a first switch tube Q1, a second switch tube Q2, a first inductor L1, and a second capacitor C2. A first end of the first switch tube Q1 is connected to the first electrode of the first power battery 120. A first end of the second switch tube Q2 is connected to a second end of the first switch tube Q1 to form a first node a, and a second end of the second switch tube Q2 is connected to the second electrode of the first power battery 120. One end of the first inductor L1 is connected to the first node a, and an other end of the first inductor L1 is connected to the first electrode of the second power battery 220 by the charging connection device 300. One end of the second capacitor C2 is connected to the other end of the first inductor L1, and an other end of the second capacitor C2 is connected to the second electrode of the first power battery 120. The discharging control device 110 is further connected to control ends of the first switch tube Q1 and the second switch tube Q2 to respectively control the first switch tube Q1 and the second switch tube Q2 to be turned on or off.

The first switch tube Q1 and the second switch tube Q2 both may be IGBT tubes or MOS tubes.

Specifically, referring to FIG. 4, when the first switch tube Q1 is turned on and the second switch tube Q2 is turned off, a loop is formed by the first power battery 120, the first inductor L1, and the second power battery 220, and a voltage of the second power battery 220 is equal to a voltage of the first power battery 120 minus a voltage of the first inductor L1. When the first switch tube Q1 and the second switch tube Q2 are both turned off, a loop is formed by the first inductor L1, the second power battery 220, and a diode of the second switch tube Q2, and the voltage of the second power battery 220 is equal to the voltage of the first inductor L1 minus a voltage across the diode. Therefore, by designing the parameter values of the first inductor L1 and the second capacitor C2 and controlling the first switch tube Q1 to be turned on or off, the DC step-down charging of the second power battery 220 by the first power battery 120 can be realized. It should be noted that the control end of the second switch tube Q2 may also be idle, that is, not connected to the discharging control device 110 and is always in an off state.

It should be noted that a step-down circuit is formed by the motor control circuit 130, the motor M, and the first capacitor C1. The motor control circuit 130 includes three-phase bridge arms U, V, and W. A switch tube is disposed on each of an upper bridge arm and a lower bridge arm of each-phase bridge arm. Midpoints of the upper bridge arm and the lower bridge arm of each phase bridge arm are connected to the corresponding winding inductors of the motor. Specifically, the midpoint of the phase-U bridge arm is connected to the phase-A winding inductor LA, the midpoint of the phase-V bridge arm is connected to the phase-B winding inductor LB, and the midpoint of the phase-W bridge arm is connected to the phase-C winding inductor LC. During the discharging of the first power battery 110, each-phase bridge arm of the motor control circuit 130 can work independently, each-phase bridge arm can work synchronously, and each-phase bridge arm can perform phase alternating according to a preset phase difference. A step-down principle of the step-down circuit formed by the motor control circuit 130, the motor M, and the first capacitor C1 is similar to a step-down principle of the step-down circuit 400, and therefore details are not described herein.

Specifically, a first discharging branch is formed by the motor M and the motor control circuit 130, and a second discharging branch is formed by the step-down circuit 400. The first discharging branch and the second discharging branch are disposed in parallel between the first power battery 120 and the second power battery 220. The first power battery 120 may perform discharging to the second power battery 220 through one of the first discharging branch or the second discharging branch.

In this embodiment, the step-down circuit 400 is disposed in the discharging vehicle 100. The step-down circuit formed by the motor control circuit 130, the motor M, and the first capacitor C1 and the step-down circuit 400 are disposed in parallel between the two power batteries, which realizes the redundant step-down design. The step-down circuit 400 is simple and is easy to implement. By means of the step-down circuit, the discharging vehicle 100 can still realize the DC step-down charging of the to-be-charged vehicle 200 when the motor control circuit 130 and the motor M are faulty.

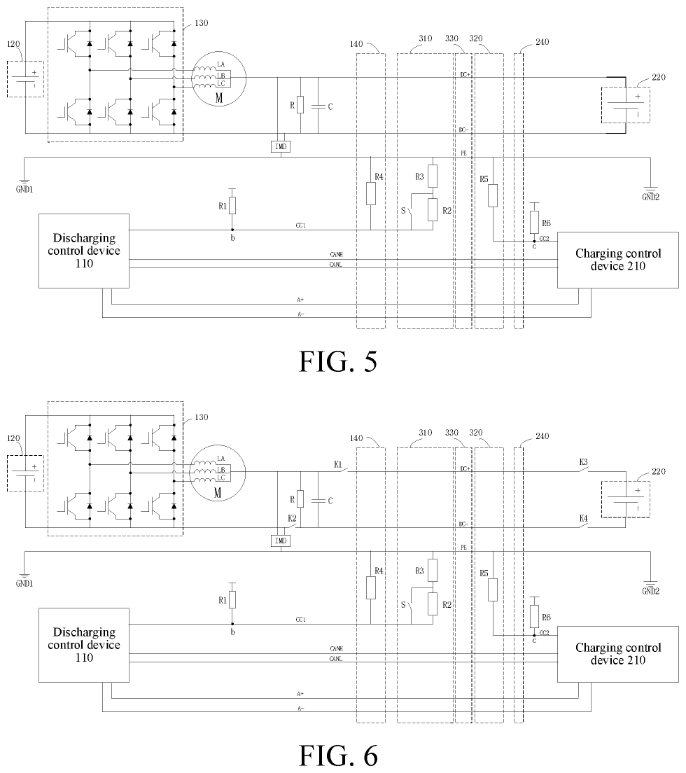

Further, as shown in FIG. 5, a first adapter portion 310 includes a second resistor R2, a third resistor R3, and a trigger switch S. One end of the second resistor R2 is connected to a CC1 pin of the first adapter portion 310. One end of the third resistor R3 is connected to a PE pin of the first adapter portion 310. An other end of the third resistor R3 is connected to an other end of the second resistor R2. The trigger switch S is connected in parallel to the second resistor R2. In this example, the discharging outlet 140 includes a fourth resistor R4, and the discharging vehicle 100 further includes a first resistor R1. One end of the fourth resistor R4 is connected to a PE hole of the discharging outlet 140, and an other end of the fourth resistor R4 is connected to one end of the first resistor R1 to form a first detection point b. An other end of the first resistor R1 is connected to a first pull-up voltage U1.

During mating between the first adapter portion 310 and the discharging outlet 140, turn-on of the trigger switch S may be used as a trigger condition. Therefore, when the switch S is turned on, the vehicle is caused to enter a travel-forbidden state through interlocking or other control measures.

In this embodiment, the discharging control device 110 is further configured to detect a voltage of the first detection point b, and determine a status of the connection between the first adapter portion 310 and the discharging outlet 140 according to the voltage of the first detection point b. The connection status includes unconnected, semi-connected, fully connected, and the like.

In an embodiment of the present disclosure, as shown in FIG. 6, the discharging vehicle 100 further includes a first switch K1 and a second switch K2. One end of the first switch K1 is connected to the neutral wire N, and an other end of the first switch K1 is connected to a DC+ hole of the discharging outlet 140. One end of the second switch K2 is connected to the second electrode of the first power battery 120, and an other end of the second switch K2 is connected to a DC− hole of the discharging outlet 140.

In this embodiment, the discharging control device 110 is further configured to control, according to the status of the connection between the first adapter portion 310 and the discharging outlet 140 or charging and discharging data, the first switch K1 and the second switch K2 to be turned on or off.

In an embodiment of the present disclosure, the discharging control device 110 is further configured to: acquire a minimum value of a maximum allowable discharging current of the discharging vehicle 100, a maximum allowable charging current of the to-be-charged vehicle 200, and a maximum allowable passing current of the charging connection device 300; and perform single-phase charging on the second power battery 220 by using the motor control circuit 130 when the minimum value is less than a first preset value; perform two-phase charging on the second power battery 220 by using the motor control circuit 130 when the minimum value is greater than or equal to the first preset value and less than a second preset value; or perform three-phase charging on the second power battery 220 by using the motor control circuit 130 when the minimum value is greater than or equal to the second preset value.

The first preset value and the second preset value may be calibrated as required. It should be noted that when the second resistor R2 and the third resistor R3 in the first adapter portion 310 have different resistance values, the maximum allowable passing current of the charging connection device 300 are different.

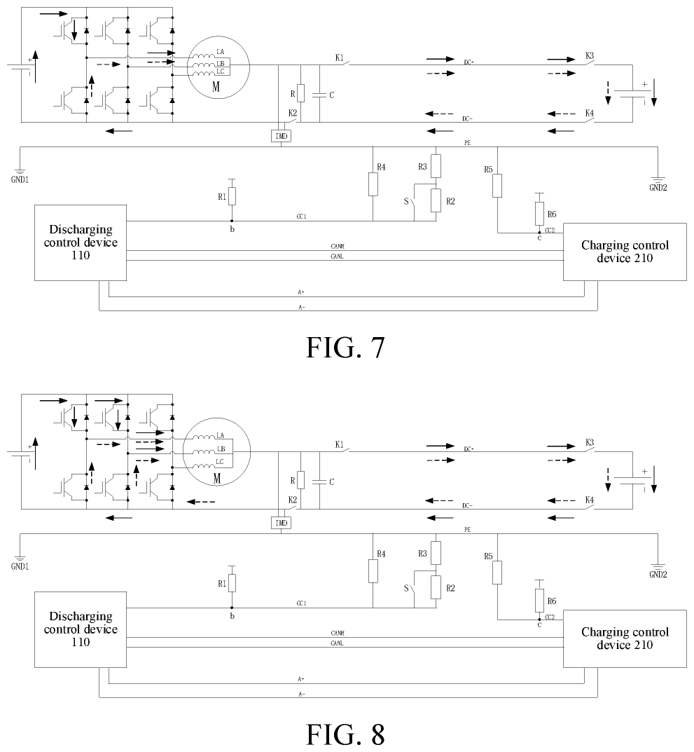

Specifically, as shown in FIG. 7, when the minimum value of the maximum allowable discharging current of the discharging vehicle 100, the maximum allowable charging current of the to-be-charged vehicle 200, and the maximum allowable passing current of the charging connection device 300 is less than the first preset value, the discharging control device 110 of the discharging vehicle 100 may control a single phase-U upper-bridge IGBT to be turned on or off, so as to realize the single-phase DC charging of the to-be-charged vehicle 200. When the upper-bridge IGBT is turned on, the discharging vehicle 100 stores energy in the inductor LA and charges the second power battery 220 of the to-be-charged vehicle 200 through a solid-line loop in the figure. When the upper-bridge IGBT is turned off, the inductor LA releases the energy to charge the second power battery 220 of the to-be-charged vehicle 200, and freewheels through a diode in a lower-bridge IGBT (see a dashed-line loop in FIG. 7). It should be noted that single phase-V charging and single phase-W charging are similar to the single phase-U charging, and therefore details are not described herein again.

Specifically, as shown in FIG. 8, when the minimum value of the maximum allowable discharging current of the discharging vehicle 100, the maximum allowable charging current of the to-be-charged vehicle 200, and the maximum allowable passing current of the charging connection device 300 is greater than or equal to the first preset value and less than the second preset value, the discharging control device 110 of the discharging vehicle 100 controls the phase-U and phase-V upper-bridge IGBTs to be turned on or off, so as to realize the two-phase DC charging of the to-be-charged vehicle 200. When the upper-bridge IGBTs are turned on, the discharging vehicle 100 stores energy in the inductor LA and the inductor LB, and charges the second power battery 220 of the to-be-charged vehicle 200 through a solid-line loop in the figure. When the upper-bridge IGBTs are turned off, the inductor LA and the inductor LB release the energy to charge the second power battery 220 of the to-be-charged vehicle 200, and freewheel through corresponding diodes in the lower-bridge IGBT (see a dashed-line loop in FIG. 8). Certainly, the two-phase charging may selectively be phase-V and phase-W charging or phase-U and phase-W charging, and charging loops thereof are similar to that of phase-U and phase-V charging.

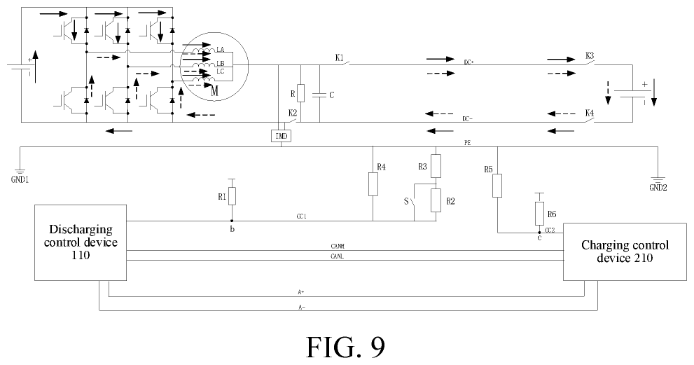

Specifically, as shown in FIG. 9, when the minimum value of the maximum allowable discharging current of the discharging vehicle 100, the maximum allowable charging current of the to-be-charged vehicle 200, and the maximum allowable passing current of the charging connection device 300 is greater than the second preset value, the discharging control device 110 of the discharging vehicle 100 controls the phase-U, phase-V, and phase-W upper-bridge IGBTs to be turned on or off, so as to realize the three-phase DC charging of the to-be-charged vehicle 200. When the upper-bridge IGBTs are turned on, the discharging vehicle 100 stores energy in the inductors LA, LB, and LC and charges the second power battery 220 of the to-be-charged vehicle 200 through a solid-line loop. When the upper-bridge IGBTs are turned off, the inductors LA, LB, and LC release the energy to charge the second power battery 220 of the to-be-charged vehicle 200, and freewheel through corresponding diodes in the lower-bridge IGBT (see a dashed-line loop in FIG. 9). It should be noted that during the three-phase charging, the phase-U, phase-V, and phase-W upper-bridge IGBTs may be controlled to be turned on or off in the following two manners: In a manner, the three-phase upper-bridge IGBTs are turned on or off simultaneously, and a phase difference is zero. In an other manner, the three-phase upper-bridge IGBTs are alternately turned on or off, and a phase difference is 120°.

Thus, the discharging control device 110 acquires three-phase control signals. The three-phase control signals include a first control signal, a second control signal, and a third control signal that are sequentially different from each other by a preset phase. The discharging control device 110 controls, according to the first control signal, the two switch tubes of the phase-U bridge arm to alternately turn on, controls, according to the second control signal, the two switch tubes of the phase-V bridge arm to alternately turn on, and controls, according to the third control signal, the two switch tubes of the phase-W bridge arm to alternately turn on, to charge the external power battery. By means of the alternate three-phase control of the three-phase bridge arms, the DC side ripples are reduced, and the charging power of the external power battery can be effectively increased.

In this embodiment, compared with single-phase charging, the two-phase charging and the three-phase charging have larger charging speeds. Similarly, compared with the two-phase charging, the three-phase charging has a larger charging speed, which can greatly shorten the charging time and realize fast DC charging. In addition, by determining the current, the safety of the charging can be further improved, and the charging speed can be increased to a certain extent.

The present disclosure further provides a vehicle charging system. Referring to FIG. 1, the vehicle charging system includes the discharging vehicle 100 in the above embodiment, a to-be-charged vehicle 200, and a charging connection device 300 connected therebetween.

Referring to FIG. 1, the to-be-charged vehicle 200 includes a charging control device 210 and a second power battery 220. A first electrode of the second power battery 220 is connected to the neutral wire N by the charging connection device 300, and a second electrode of the second power battery 220 is connected to the second electrode of the first power battery 120 by the charging connection device 300. The first electrode may be a positive electrode and the second electrode may be a negative electrode.

The vehicle charging system can realize, by using the motor control circuit and the motor windings of the discharging vehicle, charging of a low-voltage electric vehicle by a high-voltage electric vehicle. The structure is simple and is easy to realize, and the cost is low.

In an embodiment of the present disclosure, as shown in FIG. 5, a charging outlet 240 is disposed on the to-be-charged vehicle 200, and the charging connection device 300 includes a first adapter portion 310, a second adapter portion 320, and a cable harness 330. The first adapter portion 310 is adaptively connected to the discharging outlet 140. The second adapter portion 320 is adaptively connected to the discharging outlet 240; The cable harness 330 is connected between the first adapter portion 310 and the second adapter portion 320.

Specifically, referring to FIG. 5, the cable harness 330 includes a DC+ line, a DC− line, a PE line, a CANH line, a CANL line, an A+ line, and an A− line. A DC+ pin, a DC− pin, a PE pin, a CANH pin, a CANL pin, an A+ pin, and an A− pin are disposed on each of the first adapter portion 310 and the second adapter portion 320, and are respectively correspondingly connected to the DC+ line, the DC− line, the PE line, the CANH line, the CANL line, the A+ line, and the A− line. A CC1 pin and a CC2 pin are further disposed on each of the first adapter portion 310 and the second adapter portion 320.

Correspondingly, a CC1 hole, a CC2 hole, a DC+ hole, a DC− hole, a PE hole, a CANH hole, a CANL hole, an A+ hole, and an A-hole are disposed on each of the discharging outlet 140 and the charging outlet 240. The PE hole of the discharging outlet 140 is connected to a body ground GND1 of the discharging vehicle 100. The PE hole of the charging outlet 240 is connected to a body ground GND2 of the to-be-charged vehicle 200. The CANH hole and the CANL hole of the discharging outlet 140 are both connected to the discharging control device 110. The CANH hole and the CANL hole of the charging outlet 240 are both connected to the charging control device 210, so as to realize transmission of the charging and discharging data between the discharging control device 110 and the charging control device 210. The A+ hole and the A− hole of the discharging outlet 140 are both connected to the discharging control device 110. The A+hole and the A− hole of the charging outlet 240 are both connected to the charging control device 210. In this way, the discharging control device 110 provides an auxiliary power supply to the charging control device 210.

The DC+ hole, the DC− hole, the PE hole, the CANH hole, the CANL hole, the A+ hole, the A− hole, the CC1 hole, and the CC2 hole on the discharging outlet 140 are respectively correspondingly connected to the DC+ pin, the DC− pin, the PE pin, the CANH pin, the CANL pin, the A+ pin, the A− pin, the CC1 pin, and the CC2 pin on the first adapter portion 310. The DC+ hole, the DC− hole, the PE hole, the CANH hole, the CANL hole, the A+ hole, the A− hole, the CC1 hole, and the CC2 hole on the charging outlet 240 are respectively correspondingly connected to the DC+ pin, the DC− pin, the PE pin, the CANH pin, the CANL pin, the A+ pin, the A− pin, the CC1 pin, and the CC2 pin on the second adapter portion 320.

As shown in FIG. 5, the second adapter portion 320 includes a fifth resistor R5. One end of the fifth resistor R5 is connected to the PE pin of the second adapter portion 320, and an other end of the fifth resistor R5 is connected to the CC2 pin of the second adapter portion 320. The to-be-charged vehicle 100 further includes a sixth resistor R6. One end of the sixth resistor R6 is connected to the CC2 hole of the charging outlet 240 to form a second detection point c, and an other end of the sixth resistor R6 is connected to a second pull-up voltage U2.

In this embodiment, the charging control device 210 is further configured to detect a voltage of the second detection point c, and determine a status of the connection between the second adapter portion 320 and the charging outlet 240 according to the voltage of the second detection point c. The connection status includes unconnected, semi-connected, fully connected, and the like.

By determining the connection status, the reliability of the charging can be improved, and the stability of the charging can be ensured to a certain extent.

It should be noted that, FIG. 5 shows only the connection between the CC1 pin of the first adapter portion 310 and the CC1 hole of the discharging outlet 140 and the connection between the CC2 pin of the second adapter portion 320 and the CC2 hole of the charging outlet 240. The charging outlet 240 further includes a resistor corresponding to the fourth resistor R4. The resistor is connected to the CC1 hole of the charging outlet 240. The first adapter portion 310 further includes a resistor corresponding to the fifth resistor R5. The resistor is connected to the CC2 hole of the discharging outlet by the CC2 pin of the first adapter portion 310, which is not shown in FIG. 5.

In an embodiment of the present disclosure, as shown in FIG. 6, the to-be-charged vehicle 200 further includes: a third switch K3 and a fourth switch K4. One end of the third switch K3 is connected to the first electrode of the second power battery 220, and an other end of the third switch K3 is connected to the DC+ hole of the charging outlet 240. One end of the fourth switch K4 is connected to the second electrode of the second power battery 220, and an other end of the fourth switch K4 is connected to the DC− hole of the charging outlet 240.

In this embodiment, the charging control device 210 is further configured to control, according to the status of the connection between the second adapter portion 320 and the charging outlet 240 or charging and discharging data, the third switch K3 and the fourth switch K4 to be turned on or off.

Specifically, when the first adapter portion 310 is completely connected to the discharging outlet 140 and the second adapter portion 320 is completely connected to the charging outlet 240, the discharging control device 110 may control K1 and K2 to be closed. In this case, the discharging vehicle 100 may perform a self-check. After the self-check is completed (no abnormality), the discharging control device 110 may control K1 and K2 to be opened, and start to periodically transmit a communication handshake message to the charging control device 210. Furthermore, the charging control device 210 may control the switches K3 and K4 to be closed, so that the charging loop is connected. At the same time, the charging control device may transmit status parameters of the second power battery 220 to the discharging control device 110. After detecting that the second power battery 220 is normal, the discharging control device 110 may control the switches K1 and K2 to be closed, so that the DC power supply loop is connected.

In an embodiment of the present disclosure, an insulation detection circuit IMD may be further disposed on each of the discharging vehicle 100 and the to-be-charged vehicle 200. As shown in FIG. 9, for example, in the discharging vehicle 100, a first end of the IMD is connected to the neutral wire N, a second end is connected to the second electrode of the first power battery 120, and a third end is connected to the first body ground GND1. In addition, the IMD may further have a switching function.

In the description of the present description, reference terms such as “an embodiment”, “some embodiments”, “example”, “specific example”, or “some examples” means that the specific features, structures, materials or characteristics described with reference to the embodiment or example are included in at least one embodiment or example of the present disclosure. In this specification, exemplary descriptions of the foregoing terms do not necessarily refer to the same embodiment or example. In addition, the described specific features, structures, materials, or characteristics may be combined in a proper manner in any one or more of the embodiments or examples.

In the description of the present disclosure, it is to be understood that the orientations or positional relationships indicted by terms such as “center”, “longitudinal”, “transverse”, “length”, “width”, “thickness”, “upper”, “lower”, “front”, “rear”, “left”, “right”, “vertical”, “horizontal”, “top”, “bottom”, “interior”, “exterior”, “clockwise”, “counterclockwise”, “axial”, “radial”, and “circumferential” are the orientations or positional relationships shown in the drawings, are merely to facilitate describing the present disclosure and to simplify the description, are not intended to indicate or imply that the referenced device or element must have a particular orientation, be constructed and operated in a particular orientation, and therefore are not to be construed as limiting the present disclosure.

In addition, terms “first” and “second” are used merely for the purpose of description, and shall not be construed as indicating or implying relative importance or implying a quantity of indicated technical features. Therefore, features defining “first” and “second” can explicitly or implicitly include at least one of the features. In description of the present disclosure, “multiple” means at least two, such as two and three unless it is specifically defined otherwise.

In the present disclosure, it should be noted that unless otherwise explicitly specified and limited, the terms “mount”, “connect”, “connection”, and “fix” should be understood in a broad sense. For example, a connection may be a fixed connection, a detachable connection, or an integral connection; or the connection may be a mechanical connection or an electrical connection; or the connection may be a direct connection, an indirect connection through an intermediary, or internal communication between two elements or mutual action relationship between two elements, unless otherwise specified explicitly. The specific meanings of the above terms in the present disclosure may be understood according to specific circumstances for a person of ordinary skill in the art.

In the present disclosure, unless otherwise explicitly specified and defined, a first feature being “on” or “under” a second feature may mean that the first feature is in direct contact with the second feature, or the first feature is in indirect contact with the second feature by using an intermediate medium. Moreover, the first feature being “over”, “above”, and “on” the second feature may mean that the first feature is directly above or obliquely above the second feature, or merely means that the first feature has a larger horizontal height than the second feature. The first feature being “under”, “below” and “underneath” the second feature may mean that the first feature is directly below or obliquely below the second feature, or merely means that the first feature has a smaller horizontal height than the second feature.

Although the embodiments of the present disclosure are shown and described above, it can be understood that, the foregoing embodiments are exemplary, and cannot be construed as a limitation to the present disclosure. Within the scope of the present disclosure, a person of ordinary skill in the art may make changes, modifications, replacement, and variations to the foregoing embodiments.

What is claimed is:

1. A discharging vehicle, comprising a discharging control device, a first power battery, a motor, and a motor control circuit, wherein the motor comprises three-phase winding inductors and a neutral wire connected to the three-phase winding inductors, a first electrode of the first power battery is connected to a first input terminal of the motor control circuit, a second electrode of the first power battery is connected to a second input terminal of the motor control circuit, and three output terminals of the motor control circuit are respectively connected to the three-phase winding inductors, wherein
when the discharging vehicle establishes a charging connection to an external to-be-charged vehicle by using an external charging connection device, the neutral wire is connected to a first electrode of a second power battery of the to-be-charged vehicle by the charging connection device, the second electrode of the first power battery is connected to a second electrode of the second power battery by the charging connection device, and the discharging control device is configured to control the motor control circuit, so as to realize DC step-down charging of the second power battery by the first power battery.

2. The discharging vehicle according to claim 1, further comprising:
a bleeder resistor, wherein one end of the bleeder resistor is connected to the neutral wire, and an other end of the bleeder resistor is connected to the second electrode of the first power battery; and
a first capacitor, connected in parallel to the bleeder resistor.

3. The discharging vehicle according to claim 1, further comprising:
a step-down circuit, wherein a first input terminal of the step-down circuit is connected to the first electrode of the first power battery, a second input terminal of the step-down circuit is connected to the second electrode of the first power battery, a first output terminal of the step-down circuit is connected to the first electrode of the second power battery by the charging connection device, a second output terminal of the step-down circuit is connected to the second electrode of the second power battery by the charging connection device, and the step-down circuit is configured to realize the DC step-down charging of the second power battery by the first power battery.

4. The discharging vehicle according to claim 3, wherein the step-down circuit comprises:
a first switch tube, wherein a first end of the first switch tube is connected to the first electrode of the first power battery;
a second switch tube, wherein a first end of the second switch tube is connected to a second end of the first switch tube to form a first node, and a second end of the second switch tube is connected to the second electrode of the first power battery;
a first inductor, wherein one end of the first inductor is connected to the first node, and an other end of the first inductor is connected to the first electrode of the second power battery by the charging connection device; and
a second capacitor, wherein one end of the second capacitor is connected to the other end of the first inductor, and an other end of the second capacitor is connected to the second electrode of the first power battery, wherein
the discharging control device is further connected to control ends of the first switch tube and the second switch tube to respectively control the first switch tube and the second switch tube to be turned on or off.

5. The discharging vehicle according to claim 4, wherein a first discharging branch is formed by the motor and the motor control circuit, a second discharging branch is formed by the step-down circuit, the first discharging branch and the second discharging branch are disposed in parallel between the first power battery and the second power battery, and the first power battery performs discharging to the second power battery through one of the first discharging branch or the second discharging branch.

6. The discharging vehicle according to claim 1, wherein a discharging outlet is disposed on the discharging vehicle to be adaptively connected to a first adapter portion of the charging connection device, a DC+ hole, a DC− hole, a PE hole, a CANH hole, a CANL hole, an A+ hole, an A− hole, a CC1 hole, and a CC2 hole are disposed on the discharging outlet, the DC+ hole and the DC− hole of the discharging outlet are respectively connected to the neutral wire and the second electrode of the first power battery, the PE hole of the discharging outlet is connected to a body ground of the discharging vehicle, the CANH hole and the CANL hole of the discharging outlet are both connected to the discharging control device, and the A+ hole and the A− hole of the discharging outlet are both connected to the discharging control device, wherein
when the discharging outlet is adaptively connected to the first adapter portion, the DC+hole, the DC− hole, the PE hole, the CANH hole, the CANL hole, the A+ hole, the A− hole, the CC1 hole, and the CC2 hole on the discharging outlet are respectively correspondingly connected to a DC+ pin, a DC− pin, a PE pin, a CANH pin, a CANL pin, an A+ pin, an A− pin, a CC1 pin, and a CC2 pin on the first adapter portion.

7. The discharging vehicle according to claim 6, wherein the first adapter portion comprises a second resistor, a third resistor, and a trigger switch, one end of the second resistor is connected to the CC1 pin of the first adapter portion, one end of the third resistor is connected to the PE pin of the first adapter portion, an other end of the third resistor is connected to an other end of the second resistor, and the trigger switch is connected in parallel to the second resistor, wherein
the discharging outlet comprises a fourth resistor, the discharging vehicle further comprises a first resistor, one end of the fourth resistor is connected to the PE hole of the discharging outlet, an other end of the fourth resistor is connected to one end of the first resistor to form a first detection point, and an other end of the first resistor is connected to a first pull-up voltage, wherein
the discharging control device is further configured to detect a voltage of the first detection point, and determine a status of the connection between the first adapter portion and the discharging outlet according to the voltage of the first detection point.

8. The discharging vehicle according to claim 7, further comprising:
a first switch, wherein one end of the first switch is connected to the neutral wire, and an other end of the first switch is connected to the DC+ hole of the discharging outlet;
a second switch, wherein one end of the second switch is connected to the second electrode of the first power battery, and an other end of the second switch is connected to the DC− hole of the discharging outlet, wherein
the discharging control device is further configured to control, according to the status of the connection between the first adapter portion and the discharging outlet or charging and discharging data, the first switch and the second switch to be turned on or off.

9. The discharging vehicle according to claim 1, wherein the discharging control device is further configured to control the motor control circuit to realize single-phase charging or two-phase charging or three-phase charging of the second power battery.

10. The discharging vehicle according to claim 9, wherein the discharging control device is further configured to:
acquire a minimum value of a maximum allowable discharging current of the discharging vehicle, a maximum allowable charging current of the to-be-charged vehicle, and a maximum allowable passing current of the charging connection device; and
perform single-phase charging on the second power battery by using the motor control circuit when the minimum value is less than a first preset value;
perform two-phase charging on the second power battery by using the motor control circuit when the minimum value is greater than or equal to the first preset value and less than a second preset value; or
perform three-phase charging on the second power battery by using the motor control circuit when the minimum value is greater than or equal to the second preset value.

11. A vehicle charging system, comprising: the discharging vehicle according to claim 1, a to-be-charged vehicle, and a charging connection device connected therebetween, wherein
the to-be-charged vehicle comprises a second power battery, a first electrode of the second power battery is connected to the neutral wire by the charging connection device, and a second electrode of the second power battery is connected to the second electrode of the first power battery by the charging connection device.

12. The vehicle charging system according to claim 11, wherein a charging outlet is disposed on the to-be-charged vehicle, and the charging connection device comprises:
a first adapter portion, adaptively connected to the discharging outlet of the discharging vehicle;
a second adapter portion, adaptively connected to the discharging outlet; and
a cable harness, connected between the first adapter portion and the second adapter portion.

13. The vehicle charging system according to claim 12, wherein the cable harness comprises a DC+ line, a DC− line, a PE line, a CANH line, a CANL line, an A+ line, and an A− line, wherein
a DC+ pin, a DC− pin, a PE pin, a CANH pin, a CANL pin, an A+ pin, and an A− pin are disposed on each of the first adapter portion and the second adapter portion, and are respectively correspondingly connected to the DC+ line, the DC− line, the PE line, the CANH line, the CANL line, the A+ line, and the A− line, wherein
a CC1 pin and a CC2 pin are further disposed on each of the first adapter portion and the second adapter portion.

14. The vehicle charging system according to claim 13, wherein a DC+ hole, a DC− hole, a PE hole, a CANH hole, a CANL hole, an A+ hole, an A− hole, a CC1 hole, and a CC2 hole are disposed on the charging outlet, the PE hole of the charging outlet is connected to a body ground of the to-be-charged vehicle, the CANH hole and the CANL hole of the charging outlet are both connected to the charging control device, and the A+ hole and the A− hole of the charging outlet are both connected to the charging control device, wherein
the DC+ hole, the DC− hole, the PE hole, the CANH hole, the CANL hole, the A+ hole, the A− hole, the CC1 hole, and the CC2 hole on the charging outlet are respectively correspondingly connected to the DC+ pin, the DC− pin, the PE pin, the CANH pin, the CANL pin, the A+ pin, the A− pin, the CC1 pin, and the CC2 pin on the second adapter portion.

15. The vehicle charging system according to claim 14, wherein the first adapter portion comprises a second resistor, a third resistor, and a trigger switch, one end of the second resistor is connected to the CC1 pin of the first adapter portion, one end of the third resistor is connected to the PE pin of the first adapter portion, an other end of the third resistor is connected to an other end of the second resistor, and the trigger switch is connected in parallel to the second resistor.

16. The vehicle charging system according to claim 15, wherein
the second adapter portion comprises a fifth resistor, one end of the fifth resistor is connected to the PE pin of the second adapter portion, and an other end of the fifth resistor is connected to the CC2 pin of the second adapter portion; and
the to-be-charged vehicle further comprises a sixth resistor, one end of the sixth resistor is connected to the CC2 hole of the charging outlet to form a second detection point, and an other end of the sixth resistor is connected to a second pull-up voltage, wherein
the charging control device is further configured to detect a voltage of the second detection point, and determine a status of the connection between the second adapter portion and the charging outlet according to the voltage of the second detection point.

17. The vehicle charging system according to claim 16, wherein the to-be-charged vehicle further comprises:
a third switch, wherein one end of the third switch is connected to the first electrode of the second power battery, and an other end of the third switch is connected to the DC+ hole of the charging outlet; and
a fourth switch, wherein one end of the fourth switch is connected to the second electrode of the second power battery, and an other end of the fourth switch is connected to the DC− hole of the charging outlet, wherein
the charging control device is further configured to control, according to the status of the connection between the second adapter portion and the charging outlet or charging and discharging data, the third switch and the fourth switch to be turned on or off.

18. The discharging vehicle according to claim 2, further comprising:
a step-down circuit, wherein a first input terminal of the step-down circuit is connected to the first electrode of the first power battery, a second input terminal of the step-down circuit is connected to the second electrode of the first power battery, a first output terminal of the step-down circuit is connected to the first electrode of the second power battery by the charging connection device, a second output terminal of the step-down circuit is connected to the second electrode of the second power battery by the charging connection device, and the step-down circuit is configured to realize the DC step-down charging of the second power battery by the first power battery.

19. The discharging vehicle according to claim 5, wherein a discharging outlet is disposed on the discharging vehicle to be adaptively connected to a first adapter portion of the charging connection device, a DC+ hole, a DC− hole, a PE hole, a CANH hole, a CANL hole, an A+ hole, an A− hole, a CC1 hole, and a CC2 hole are disposed on the discharging outlet, the DC+ hole and the DC− hole of the discharging outlet are respectively connected to the neutral wire and the second electrode of the first power battery, the PE hole of the discharging outlet is connected to a body ground of the discharging vehicle, the CANH hole and the CANL hole of the discharging outlet are both connected to the discharging control device, and the A+ hole and the A− hole of the discharging outlet are both connected to the discharging control device, wherein
when the discharging outlet is adaptively connected to the first adapter portion, the DC+hole, the DC− hole, the PE hole, the CANH hole, the CANL hole, the A+ hole, the A− hole, the CC1 hole, and the CC2 hole on the discharging outlet are respectively correspondingly connected to a DC+ pin, a DC− pin, a PE pin, a CANH pin, a CANL pin, an A+ pin, an A− pin, a CC1 pin, and a CC2 pin on the first adapter portion.

20. The discharging vehicle according to claim 8, wherein the discharging control device is further configured to control the motor control circuit to realize single-phase charging or two-phase charging or three-phase charging of the second power battery.
